(19) United States
(12) Patent Application Publication
(10) Pub. No.: US 2008/0261562 A1
(43) Pub. Date: Oct. 23, 2008

(54) System and Method for Providing Bidirectional Message Communication Services with Portable Terminals

(75) Inventors: Jeong-Woo Jwa, Jeju-do (KR); Gil-Sung Kang, Gyeonggi-do (KR)

Correspondence Address: SUMMA, ALLAN & ADDITON, P.A., 11610 NORTH COMMUNITY HOUSE ROAD, SUITE 200, CHARLOTTE, NC, 28277, US

(73) Assignee: IVAS KOREA CORP, Seoul (KR)

(21) Appl. No.: 12/091,501

(22) PCT Filed: Oct. 27, 2006
(86) PCT No.: PCT/KR06/04433

§ 371 Date: Apr. 25, 2008

(30) Foreign Application Priority Data
Oct. 28, 2005 (KR) 10-2005-0102356

(51) Int. Cl. H04M 1/66

(52) U.S. Cl. 455/411

(57) ABSTRACT

The present invention relates to a bidirectional message transmission system and method. The system performs first authentication on a first user based on user ID information provided by a first user terminal connected to the wired Internet, and performs second authentication in cooperation with a first portable terminal having a wireless telephone number provided by the first user terminal. The message provided by the first user terminal having undergone the first and second authentication is transmitted to at least two second users' terminals. The second users' terminals include a wireless terminal and a wired terminal. Therefore, the bidirectional communication service for concurrently transmitting the message to at least two other terminals is allowable based on stable and reliable authentication.

### BACKGROUND OF THE INVENTION

(a) Field of the Invention The present invention relates to message transmission. More particularly, the present invention relates to a bidirectional message transmission system and method thereof.

(b) Description of the Related Art

Recently, various messenger services are provided through the wired/wireless Internet, and are installed when the user directly accesses a messenger service provider's server through the Internet and downloads a messenger program into his terminal. The user drives a messenger program to undergo a user authentication process and then transmits a short message to another user's terminal.

However, the conventional messenger service only provides a function for transmitting messages on the wired Internet and does not provide a function for receiving calls, and its billing process for the fee is performed only by a messenger operator. Also, the PC's operating system (O/S) has no easy function for sending a message to a cell phone. Accordingly, the message transmission service from the cell phone to the web and from the web to the cell phone is not activated.

In addition, the other user's terminal for receiving the short message is also the personal computer on the same O/S basis.

### SUMMARY OF THE INVENTION

The present invention has been made in an effort to provide a message transmission system and method thereof having advantages of increasing service satisfaction caused by increase of convenience by concurrently transmitting a predetermined message to at least two terminals connected with each other. The present invention has been made in another effort to provide a bidirectional communication service between a wired network user and a wireless network user by controlling a wireless terminal to receive a message from a wired terminal connected to the wired Internet.

The present invention has been made in another effort to bill the fee of the wired terminal having used the message transmission service by using a wireless terminal designated by the user.

The present invention has been made in another effort to provide a stable and reliable authentication method to the user using a message transmission service.

In one aspect of the present invention, a message transmission method in a system connected to a plurality of user terminals through a network includes: a) the system receiving user ID information and a wireless telephone number from a first user's terminal having a client processing device; b) the system performing first authentication on the first user depending on whether the user ID information is stored in a database for storing information on users who are available for a service; c) when the first authentication is finished, performing second authentication on the first user in cooperation with a portable terminal having the wireless telephone number; d) receiving a message and at least two receiving designated information from the client processing device of the first user terminal having undergone the first and second authentication; and e) simultaneously transmitting the message to at least two second users' terminals based on the receiving designated information.

In another aspect of the present invention, a message transmission method in a system connected to a plurality of user terminals through a network includes: a) the system performing first authentication on a first user based on user ID information provided by a first user terminal connected to the wired Internet wherein the user terminal includes a client processing device; b) the system receiving a wireless telephone number from the first user terminal, and performing second authentication in cooperation with a first portable terminal having the wireless telephone number; and c) the system transmitting a message provided by the first user terminal having undergone the first and second authentication to at least two second users' terminals, wherein the second users' terminals include a wireless terminal and a wired terminal. The step for performing second authentication includes: transmitting a proper number for authentication to the portable terminal having the wireless telephone number; and performing the second authentication according to whether the proper number provided by the first user terminal corresponds to the proper number transmitted to a portable terminal having the wireless telephone number. The step for performing second authentication includes: transmitting a message including a callback URL to a portable terminal having the wireless telephone number; and performing the second authentication when the first user is connected based on the callback URL message transmitted to the portable terminal, wherein the system notifies the first user terminal of an authentication finish when the second authentication is finished.

In another aspect of the present invention, a message transmission system connected to a plurality of user terminals through a network includes: an authentication server for authenticating a user; a message transmission server for concurrently transmitting a message provided by the authenticated first user terminal to at least two second users' terminals; and a billing server for performing a billing process according to the first user's message transmission, wherein the message transmission server transmits the message in cooperation with a client processing device installed in the first user terminal, and the second user terminal includes a wired terminal and a wireless terminal.

### BRIEF DESCRIPTION OF THE DRAWINGS

FIG. 1 shows a network connection state for a bidirectional message transmission system according to an embodiment of the present invention.

FIG. 2 shows a schematic diagram for a bidirectional message transmission system according to an embodiment of the present invention.

FIG. 3 shows a schematic diagram for a user terminal according to an embodiment of the present invention.

FIG. 4 shows a flowchart for a message transmission process according to an embodiment of the present invention.

FIG. 5 shows a message transmission process shown in FIG. 4.

FIG. 6 shows a function diagram for a mouse for message transmission of contents according to an embodiment of the present invention.

FIG. 7 shows a flowchart for an authentication process according to an embodiment of the present invention.

FIG. 8 shows a flowchart for another authentication process according to an embodiment of the present invention.

FIG. 9 shows a flowchart for an authentication cancellation process according to an embodiment of the present invention.

FIG. 10 shows a flowchart for a billing process according to an embodiment of the present invention.

FIG. 11 shows a billing data format according to an embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, unless explicitly described to the contrary, the word “comprise”, and variations such as “comprises” or “comprising”, will be understood to imply the inclusion of stated elements but not the exclusion of any other elements.

Further, the term of a module over the present specification represents a unit for processing a predetermined function or operation, which is realized by hardware, software, or combination of hardware and software.

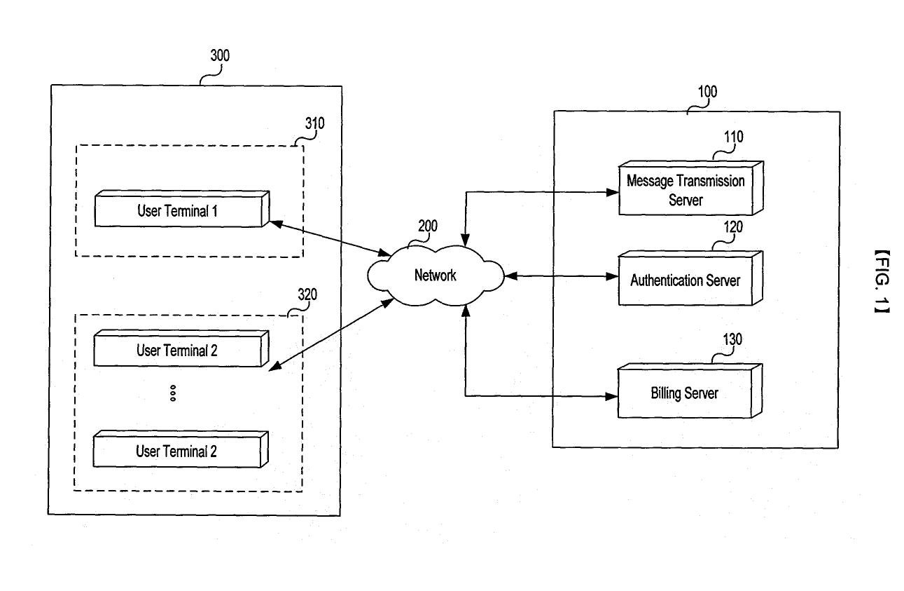

FIG. 1 shows a network connection state for a bidirectional message transmission system according to an embodiment of the present invention.

As shown in FIG. 1, the bidirectional message transmission system (for ease of description, referred to as a “message transmission system” 100) is connected to a plurality of user terminals 300 through a network (including wired/wireless networks including the Internet, wireless communication networks, satellite communication networks, and future networks) 200.

The user terminal 300 is a communication device for accessing the message transmission system 100 through the network 200 and receiving a predetermined message transmission service, and in detail, it includes wired terminals including a computer accessible to the network 200 through a cable and an Internet TV and wireless terminals including a cell phone wirelessly accessible to the network 200 and a PDA.

In the present exemplary embodiment, the user terminal 300 will be classified as a first user terminal 310 for transmitting messages and at least one second user terminal 320 for receiving messages according to message transmission and receiving mechanism. The first user terminal is a wired terminal connected to the wired Internet, and the second user terminal is a wireless terminal connected to a wired terminal or/and a mobile communication network. However, the present invention is not restricted to this.

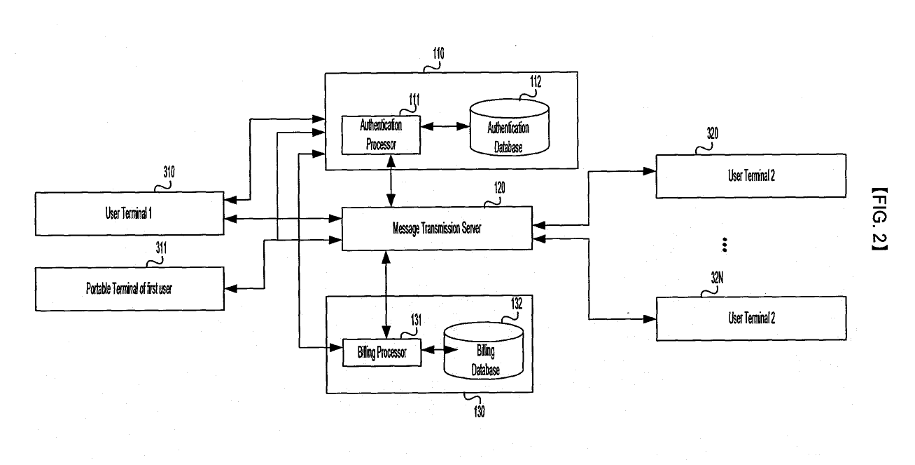

FIG. 2 shows a detailed schematic diagram for a bidirectional message transmission system according to an embodiment of the present invention.

As shown in FIG. 2, the message transmission system 100 includes a message transmission server 110, an authentication server 120, and a billing server 130.

The message transmission server 110 transmits a predetermined message to at least one terminal according to the user request. In detail, the message transmission server 110 receives a predetermined message from the first user terminal 310, receives information on the second user terminal (320, . . . , 32N), and transmits the message to at least one second user terminal.

The authentication server 120 authenticates the users who desire to receive a message transmission service, and the billing server 130 bills the usage on the message transmission service. Particularly, the authentication server 120 and the billing server 130 performs authentication and billing by using a wireless telephone number, and performs authentication and billing in cooperation with a client module installed in the user terminal 300.

For this purpose, the authentication server 120 includes an authentication processor 111 for performing authentication and an authentication database 112 for storing user information available for the service, and the authentication processor 111 authenticates the user based on information stored in the authentication database 112. In this instance, the user information includes at least one of a user ID, a password, a hardware MAC (Media Access Control) address provided to the user terminal, an IP (internet protocol) address, a port address, and an application service ID. In this instance, the IP address is a fixed IP.

The billing server 130 includes a billing processor 131 for billing the service used by the authenticated user terminal in cooperation with the authentication server 120 and the message transmission server 110, and a billing database 132 for storing a billing history for each user. In this instance, other services provided to the user through the network in addition to the message transmission service can be billed.

The authentication server 120 and the billing server 130 are servers controlled by a mobile communication service provider, and transmit a message to a portable terminal having a predetermined wireless telephone number. Also, the message transmission server 110 is controllable by the mobile communication service provider, and is controllable by another Internet service provider.

A predetermined client module is installed in the user terminal 300 so as to use a message transmission service through the above-configured message transmission system 100. The client module is installed in the terminal 300 when it is provided by the message transmission system 100 in the initial access to the message transmission system 100, and the user terminal 300 checks the version of the client module each time the user terminal 300 accesses the system 100, and an update for the client module is performed if needed. The client module includes a message program (e.g., a messenger program.)

For better comprehension and ease of description, the client module installed in the terminal and receiving a predetermined service through the message transmission system will be referred to as a “client processing device.”

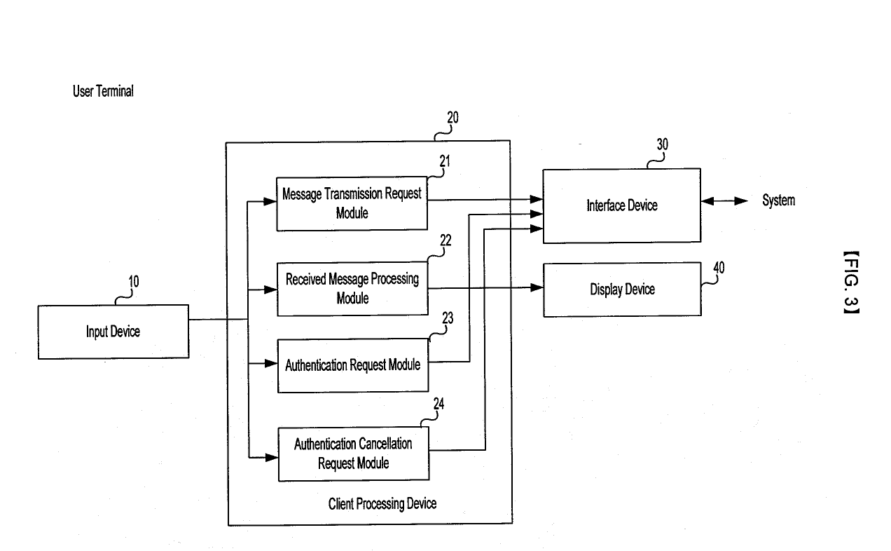

FIG. 3 shows a schematic diagram for a user terminal according to an embodiment of the present invention.

As shown in FIG. 3, the user terminal 300 includes an input device 10, a client processing device 20, an interface device 30, and a display device 40.

The input device 10 includes a mouse and a keyboard, and the interface device 30 includes a LAN card having a function for accessing the network 200. The display device 40 displays information processed on the terminal 300 and information transmitted through the network.

As shown in FIG. 3, the client processing device 20 installed in the user terminal 300 to transmit messages, authenticate the user, and billing the service includes a message transmission request module 21 for providing a message to the system 100 and requesting to transmit the message, a received message processing module 22 for receiving and processing the message transmitted by a predetermined terminal through the system 100, an authentication request module 23 for requesting authentication from the system 100 so as to use a service, and an authentication cancellation request module 24 for requesting authentication cancellation from the system 100. Also, while transmitting predetermined contents directly input through a predetermined input device 10 connected to the terminal 300 or predetermined contents selected by the input device 10 to the system 100, the message transmission request module 21 requests to transmit the same contents in a message format.

The client processing device 20 transmits and receives messages to/from a predetermined terminal, and authenticates subscribers for using the service in cooperation with the system 100. The subscriber authentication will be used to bill and settle the service caused by transmitting/receiving the message. The modules configuring the client processing device 20 are classified according to their functions, and different classification is possible.

The message transmitted/received through the system includes text contents and may further include multimedia contents, sound, and picture contents. The message includes an SMS (Short Message Service) type message, an LMS (Long Message Service) type message, an EMS (Enhanced Message), an MMS (Multimedia Message), a callback URL type message for accessing a predetermined wap page of the system, and a callback number type message for connecting a call to the system.

Further, the contents included in the message include contents provided by the system 100, contents directly input by the user, and contents processed in the user terminal.

An operation by the message transmission system according to an embodiment of the present invention will now be described.

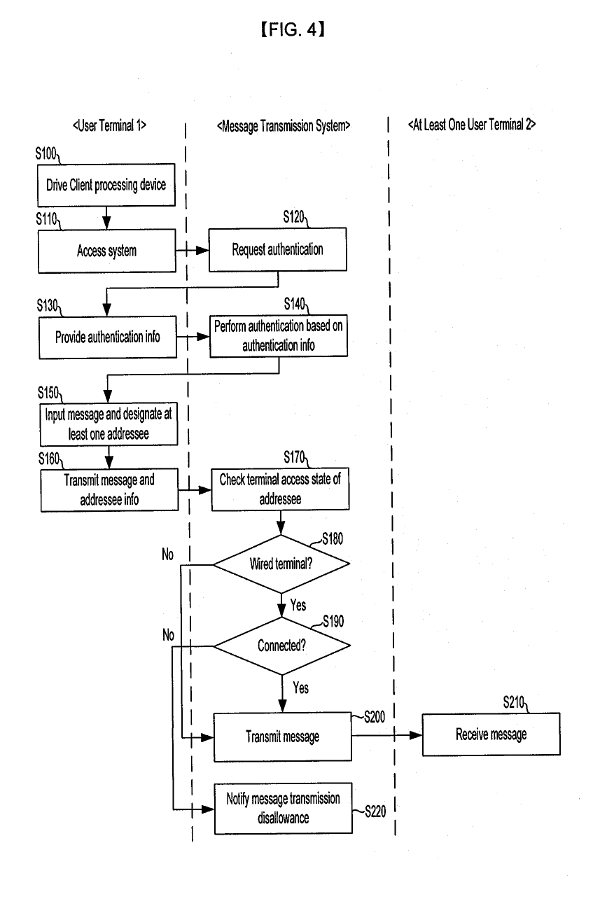

FIG. 4 shows a flowchart for a message transmission process according to an embodiment of the present invention. When the first user drives the client processing device 20 installed in the first user terminal 310 so as to transmit a message to second users, the client processing device 20 is driven to display a screen for transmitting a message on the terminal. In this instance, an access to the system 100 is performed by the message transmission request module 21 of the client processing device 20 (S100-S120).

The user is authenticated by the authentication request module 23 of the client processing device 20. The authentication process will be described in detail subsequently (S120-S140).

When the user authentication is finished, a message is transmitted to a predetermined terminal according to the user's request. In detail, the user can directly input the message to be transmitted, or he can select predetermined contents processed in the first user terminal 310 and requests to transmit a message. In addition, the user can request to transmit a message by selecting part or all the contents provided on the Internet.

When the message (including contents) are input or selected, the user designates a terminal for receiving the message, that is, at least one second user terminal (S150). For example, the user inputs a predetermined receiving address (e.g., a messenger ID) assigned to a wired terminal such as the PC or/and inputs a mobile telephone number of a mobile phone such as a cell phone. The receiving designated information (e.g., address and cell phone number) on the terminal for receiving the message is given at least one, and the message transmission request module 21 requests transmission from the system 100 while transmitting the receiving designated information and the input or selected message to the system 100 (S160).

Accordingly, the message transmission server 110 of the system 100 transmits the message to at least one second user terminal 320 based on the receiving designated information, and determines whether the designated second user terminal is connected to the system 100 (S170). In detail, when the receiving designated information has a receiving address for the wired terminal, it is determined whether the second user terminal 320 having a corresponding receiving address is connected to the system, that is, the message transmission server 110. When the second user terminal 320 is connected, the message transmission server 110 transmits the message to the second user terminal 320 (S180-S200).

Also, when a wireless telephone number is included in the receiving designated information, the message is transmitted to the second user terminal having the wireless telephone number, that is, the wireless terminal, without determining the connection state. The message is transmittable to at least one second user terminal 320 simultaneously (S200-S210).

According to the embodiment of the present invention, the user can simultaneously transmit the same message to at least one terminal, and particularly, he can simultaneously transmit the same message to a predetermined mobile terminal as well as the wired terminal. Hence, the second user having a mobile terminal can easily check a predetermined message provided through the message transmission server 110 without using a PC.

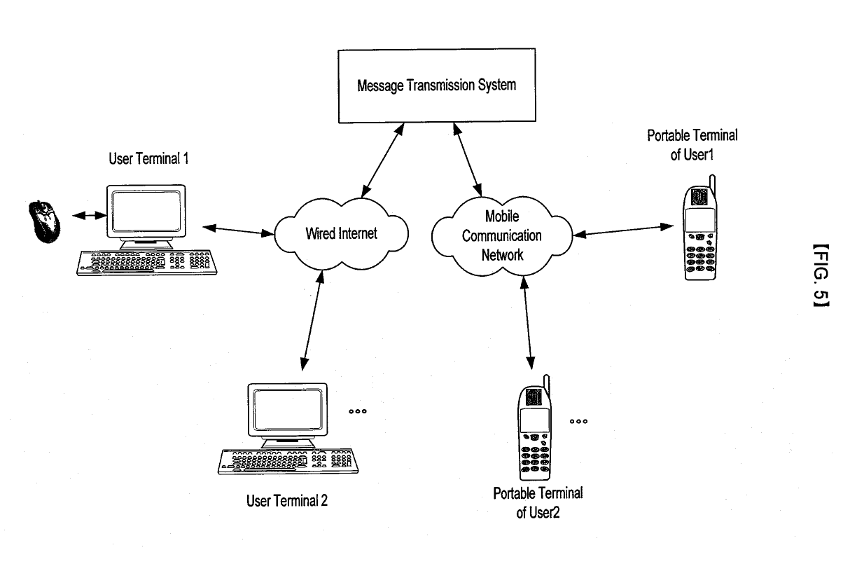

FIG. 5 shows a message transmission process described above. It is exemplified that the first user uses a wired terminal (the first user terminal) such as a PC, connected to the wired Internet to simultaneously transmit a message to the second user terminals, that is, at least one wireless terminal connected to a mobile communication network and/or at least one wired terminal connected to the wired Internet. Therefore, the first user can simultaneously transmit the same message to the second user connected to the mobile communication network and/or the second users connected to the wired Internet. Accordingly, the second user using the wireless terminal connected to the mobile communication network can easily receive the message transmitted by the wired Internet user without access the Internet.

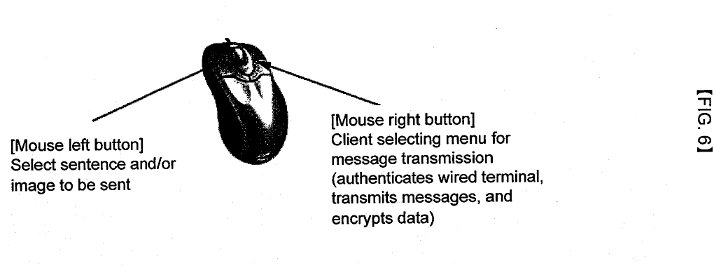

In the above-described message transmission process, the process for the user to select predetermined contents processed on the terminal or contents on the network and request to transmit a message without directly inputting the message will now be described. The first user uses an input device such as a mouse to select predetermined contents processed on the terminal or contents on the network and request to transmit a message in the step of S150. FIG. 6 shows a function performed by the button operation of the mouse.

For example, as shown in FIG. 5, when the first user using the terminal connected to the wired Internet presses the left button of the mouse to input a first signal as shown in FIG. 6, the message transmission request module 21 of the client processing device 20 selects the contents given at the point where the cursor is displayed according to the mouse operation. In this instance, the contents displayed on the screen include contents processed on the terminal by the user and contents provided by accessing the Internet. The contents are selected when the first signal is input, and predetermined contents displayed on the screen are selected until the first signal is input no longer.

When the first user presses the right button of the mouse to input a second signal, the message transmission request module 21 provides the selected contents to the message transmission server 110 of the system 100 to request the contents to be transmitted to the terminal 320 of a predetermined second user. Particularly, in this instance, the message transmission request module 21 displays a message transmission menu (e.g., a message transmission menu using a portable terminal) according to a second signal input so that the user may easily select message transmission without driving an additional message transmission program.

Also, the first user can input the second user's terminal address or wireless telephone number on the message transmission menu to designate at least one second user, or the message transmission request module 21 uses the second user's stored address or wireless telephone number to request message transmission from the server 110.

The message transmission server 110 processes the selected contents into the message format and transmits the message to a wired terminal having a predetermined address and/or a wireless terminal such as a mobile phone having a mobile telephone number according to the request provided by the client processing device 20.

Therefore, the user can easily transmit part or total of predetermined contents processed on the wired terminal or part or total contents provided on the network such as the Internet to the portable terminal. Particularly, as shown in FIG. 6, message transmission can be requested by using the left button and the drag function of the mouse to select the contents and using the right button to activate the client module. Therefore, the user easily selects a desired message by using a mouse and transmits the message to at least one second user terminal.

The second user having received the message from the first user and a third user having not received the message can transmit a predetermined message to the authenticated first user's terminal by using a wireless terminal. In this case, a phone-to-web communication service is provided by the message transmission system 100 according to the embodiment of the present invention so that bidirectional communication between the wireless terminal and the first user is available.

The authentication process will be described in further detail.

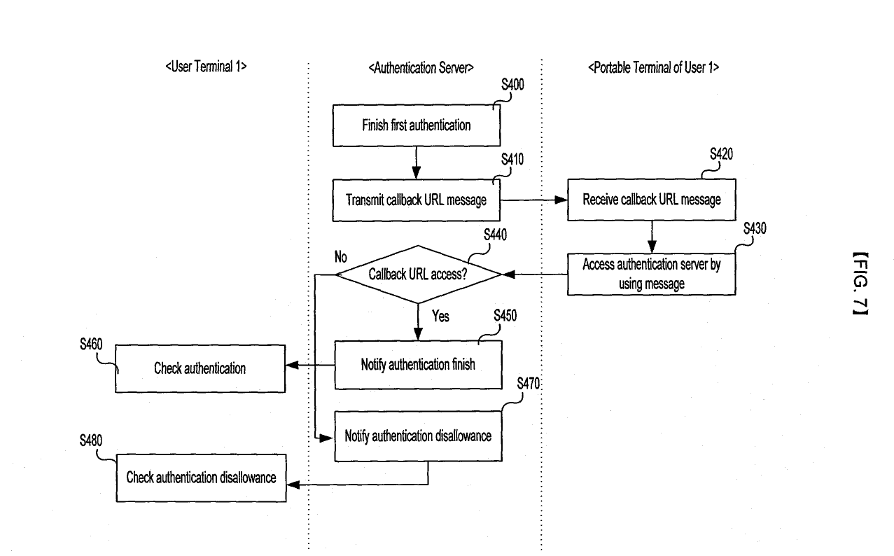

FIG. 7 shows a flowchart for an authentication process according to an embodiment of the present invention.

As shown in FIG. 7, when the access to the system 100 is given, the authentication request module 23 of the client processing device 20 transmits predetermined authentication information to the system 100 and requests to authenticate the first user terminal 310 automatically or according to the user's request when the device 20 is driven. Particularly, the authentication request module 23 requests authentication while transmitting authentication information including the first user's wireless telephone number together with user ID information including an IP/MAC address to the system 100 (S300-S310). The user ID information includes a user ID, a password, a hardware MAC address assigned to the user terminal, and an IP address. The first user's wireless telephone number includes information input in real-time by the user and information input in advance and stored in the device by the first user.

When authentication information is transmitted to the system 100 from the client processing device 20 of the first user terminal 310, the authentication server 120 of the system 100 performs user authentication based on the authentication information.

The authentication processor 111 performs first authentication to determine whether the IP/MAC address included in the transmitted authentication information is stored in the authentication database 112 (S320), and performs second authentication to transmit a proper number for authentication to the wireless telephone number included in the authentication information when the first authentication is performed that the transmitted IP/MAC address is stored in the authentication database 112 (S330-S340).

As shown in FIG. 5, the proper number is transmitted to the wireless terminal having the wireless telephone number, that is, the first user's portable terminal 311, and the first user checks the proper number transmitted to the wireless terminal 311 and inputs checking results to the client processing device 20 on the first user terminal 310 (S350-S360). The authentication request module 23 transmits the input proper number together with the authentication information (the terminal's IP/MAC address and wireless telephone number) to the authentication server 120 (S370).

When the proper number provided by the first authenticated first user terminal 310 corresponds to the proper number transmitted to the portable terminal having the wireless telephone number, the authentication server 120 determines that the first user is available for the service and finishes second authentication (S380). When the user is determined to be available after the first and second authentication, the authentication server 120 notifies the message transmission server 110 of the authentication result so that the user may receive a predetermined service (S390, S391, and S392).

The above-described second authentication may be performed in a different manner. That is, the user is controlled to be authenticated by using a portable terminal instead of inputting the proper number to the first user terminal 310.

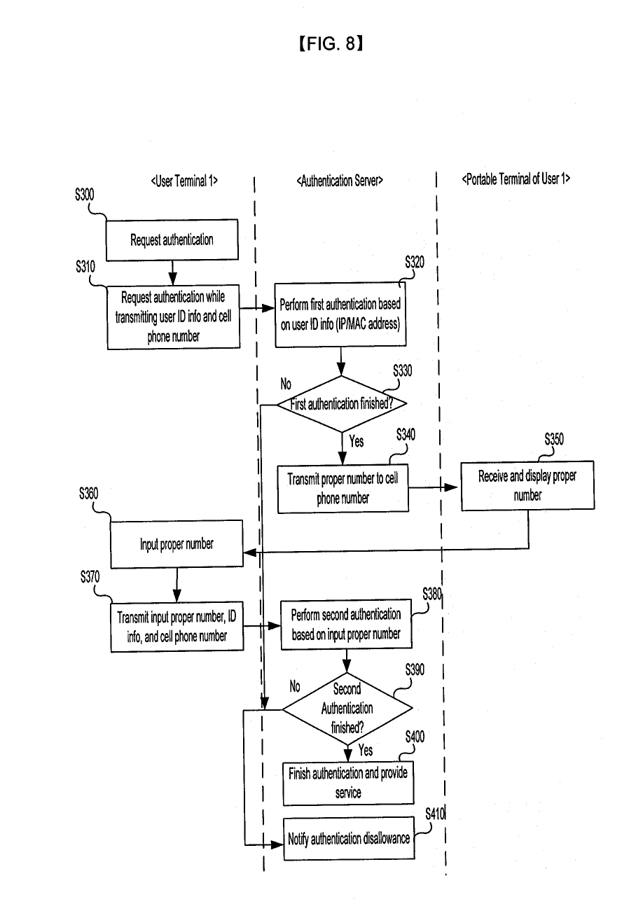

FIG. 8 shows a flowchart for another authentication process according to an embodiment of the present invention. First authentication is performed in a like manner shown in FIG. 7, and FIG. 8 shows second authentication.

As shown in FIG. 8, when the first authentication is finished, the authentication server 120 transmits a message including a callback URL for accessing a predetermined wap page to a portable terminal having the wireless telephone number (S400-S410). When the first user access the authentication server 120 to give an answer based on the message provided to the portable terminal (S420-S440), the authentication server 120 determines that the first user is a registered user and transmits authentication finish data to the first user's terminal 310 (S450-S460).

When the user authentication is performed through the various authentication methods, the message transmission service is performed as shown in FIG. 4. The authentication server 120 additionally stores authentication information on the user having accessed the service after authentication into a memory (not shown), and deletes the stored authentication information at the subsequent authentication cancellation.

Authentication cancellation for the user to whom the service is provided through various authentication processes is performed in the subsequent case.

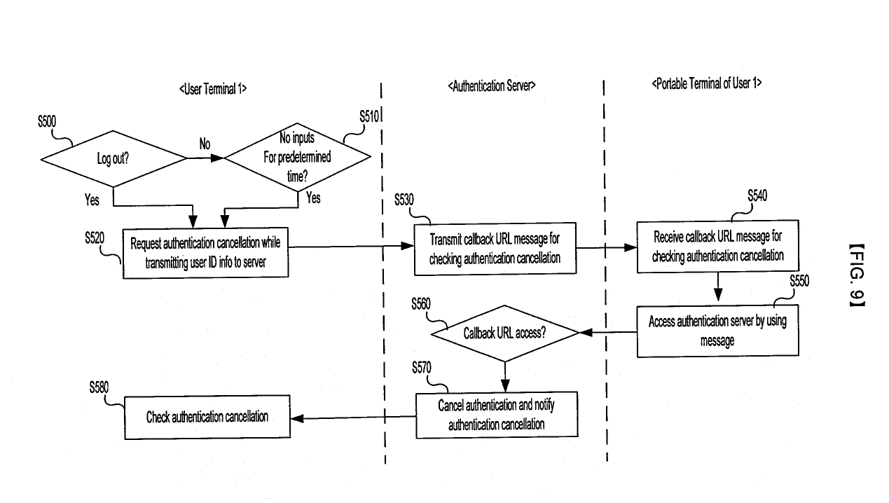

FIG. 9 shows a flowchart for an authentication cancellation process according to an embodiment of the present invention.

When the user accesses the system 100 and then logs out, the authentication cancellation request module 24 of the client processing device 20 requests to cancel authentication while transmitting an IP/MAC address to the authentication server 120 (S500). In this case, the authentication server 120 notifies the billing server 130 of authentication cancellation to terminate billing the service usage by the user, and deletes information on the user from the memory for storing information on the users who are currently connected and authenticated (S520).

When the user is authenticated by the authentication server 120, the authentication cancellation request module 24 of the client processing device 20 determines that the user uses the service no longer, transmits an IP/MAC address to the authentication server 120 and requests to cancel authentication when no service usage is input by the user for a predetermined time, that is, when the user does not request to transmit a message for a predetermined time (S510, S520).

The above-noted user's service usage state can be determined by the system 100 not by the client processing device 20 installed in the user terminal 300. That is, when the user does not use the service for a predetermined time, the billing server 130 of the system 100 requests to cancel authentication while transmitting the user's information (IP/MAC address) to the authentication server 120, and the authentication server 120 cancels authentication.

When canceling the authentication according to the authentication cancellation request, the authentication server 120 transmits a callback URL to the user's portable terminal 311 to check the user's authentication cancellation request (S530), and actually cancels authentication when the user is connected through the callback URL (S540-S570).

In addition to the above-described process, the user can request to cancel authentication from the authentication server 120 by using the callback URL message of the portable terminal.

The process for billing the service usage when the authenticated user uses the service will now be described.

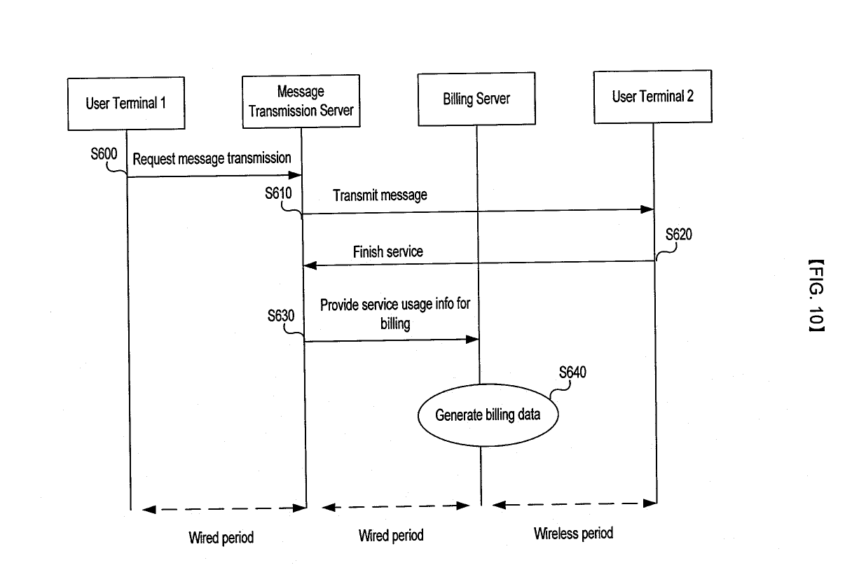

FIG. 10 shows a flowchart for a billing process according to an embodiment of the present invention.

When authentication is performed according to the message transmission request by the user and a message transmission service is performed, the billing server 130 performs billing according to information provided by the message transmission server 110 (S600-S640).

That is, the billing server 130 bills the service used by the terminal user having the ID information when receiving ID information (IP/MAC address) for a predetermined user and corresponding authentication finish results from the authentication server 120.

In detail, the billing processor 131 of the billing server 130 provides the authenticated user's ID information to the message transmission server 110 or the authentication server 120 and requests information on the service used by the user terminal having the ID information. In this instance, the billing process can be performed from the time when the user is connected and the authentication is finished to the time when the authentication is canceled, and the billing process can be performed depending on the service quantity used by the user while he is authenticated and connected to the system.

In the case of performing the billing process according to the service usage, the billing processor 131 requests information on the user's service usage from the message transmission server 110. For example, when the user requests message transmission as described above, and particularly requests the service for transmitting the message to at least one portable terminal, the message transmission server 110 provides service usage information including the usage number on the message and the number of portable terminals having transmitted the message to the billing server 130. In this instance, the billing processor 131 can request service usage information for billing from the message transmission server 110 when the user authentication is canceled by the authentication server 120.

The billing processor 131 bills the user based on the information, and particularly performs billing by using the wireless telephone number. Therefore, when the user's portable terminal usage is charged, the billing history using the wireless telephone number is also charged. That is, when the first user connected through the wired Internet has transmitted a message to a plurality of second users as shown in FIG. 5, the usage fee caused by message transmission is charged to the wireless telephone number input by the first user, which will be called a billing process using a wireless telephone number.

When the billing is performed according to the time frame when the user is connected to the system and is then being authenticated irrespective of the user's service usage, the billing processor 131 receives an authentication finish time and an authentication cancellation time following the user's initial access from the authentication server 120, and performs billing based on the authentication time generated based on the authentication finish time and the authentication cancellation time (a service available time when accessing the system and undergoing an authentication process). In this instance, the billing process using a wireless telephone number is performed.

The billing history (user ID information, service usage information, authentication time, and corresponding usage fee) of the billing processor 131 is stored in the billing database 132, and is charged when the fee caused by the billing history is charged when the portable terminal usage fee through the mobile communication service provider's system is charged.

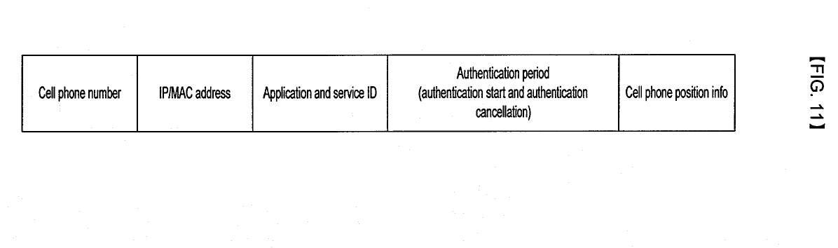

FIG. 11 shows a billing history structure according to an embodiment of the present invention. As shown in FIG. 11, the billing history, that is, billing data include a wireless telephone number provided by the user having used message transmission, an IP/MAC address of a terminal from which the first user has requested message transmission, an application service ID for indicating the service used by the user, the user's authentication time (an authentication start time and an authentication cancellation time), and position information of a portable terminal having the wireless telephone number.

The above-described authentication and billing method has exemplified the case in which the user uses a message transmission service according to the embodiment of the present invention, and the same authentication and billing method is applicable to the case in which the user uses another service without being restricted to the message transmission service.

Also, when the user's portable terminal has a PAN (personal area network) access function, the authentication server 120 performs the authentication and authentication cancellation process. In further detail, when an authentication request is provided to the user's terminal from the user's portable terminal, the user terminal's client processing device requests authentication information from the portable terminal. The client processing device authenticates the portable terminal based on the wireless telephone number provided by the portable terminal, PAN access information (ID and password), and an service authentication number, and then transmits user ID information to the authentication server 120 and requests authentication in a like manner of the above-described authentication process when the portable terminal is a registered one.

The above embodiment has described authentication, message transmission, and billing based on the case in which the first user using a wired terminal connected to the wired Internet transmits a plurality of second users, and in addition, the present invention is also applicable to the case in which the first user using a wireless terminal connected to the mobile communication network transmits a message to at least one second user terminals.

In the embodiment of the present invention, the fee for the first wired terminal connected to the wired Internet is billed to the first portable terminal designated by the user, and an illegal use on the first wired terminal authenticated by another user is prevented by performing authentication in cooperation with the first portable terminal. Also, when the user is authenticated once, he can use various charged services including a mobile communication service, charged contents, and purchase with a small sum of money during the authenticated period by using the first wired terminal.

Also, the bidirectional communication service generally provided between portable terminals is easily available by providing a phone-to-web communication service to the authenticated first wired terminal from a second portable terminal.

The method including the above-described message transmission, authentication, and billing processes can be realized into a program format recorded on a computer readable recording medium. The recording medium includes any types of recording devices for storing computer readable data, for example, a CD-ROM, a magnetic tape, a floppy disk, and a carrier wave (e.g., Internet transmission) format.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

Therefore, the user acquires further service satisfaction because of increase of convenience by concurrently transmitting or receiving a message to/from at least one or plural other terminals, which increases sales because of increase of subscribers and usage.

In addition, the wireless terminal connected to the mobile communication network can easily receive a predetermined message through the wired Internet.

Also, more stable and reliable service provision is allowed since user authentication for using services including the message transmission is performed by first authentication and second authentication. Further, the wired terminal user can easily use various services through single authentication.

Also, the user can easily transmit various contents to a portable terminal in the mobile communication network from the wired Internet by using a mouse in the PC operating system (OS).

What is claimed is:

1. A message transmission method in a system connected to a plurality of user terminals through a network, the message transmission method comprising:
a) the system receiving user ID information and a wireless telephone number from a first user's terminal having a client processing device;
b) the system performing first authentication on the first user depending on whether the user ID information is stored in a database for storing information on users who are available for a service;
c) when the first authentication is finished, performing second authentication on the first user in cooperation with a portable terminal having the wireless telephone number;
d) receiving a message and at least two receiving designated information from the client processing device of the first user terminal having undergone the first and second authentication; and
e) simultaneously transmitting the message to at least two second users' terminals based on the receiving designated information.

2. The message transmission method of claim 1, wherein c) comprises:
transmitting a proper number for authentication to the portable terminal having the wireless telephone number; and
performing the second authentication according to whether the proper number provided by the first user terminal corresponds to the proper number transmitted to a portable terminal having the wireless telephone number.

3. The message transmission method of claim 1, wherein c) comprises:
transmitting a message including a callback URL to a portable terminal having the wireless telephone number; and
performing the second authentication when the first user is connected based on the callback URL message transmitted to the portable terminal, wherein
the system notifies the first user terminal of an authentication finish when the second authentication is finished.

4. The message transmission method according to claim 1, further comprising
when receiving user ID information and an authentication cancellation request from the client processing device, the system deleting ID information on the first user from a database for storing information on users who are current connected and authenticated, to thereby cancel the authentication, wherein
the client processing device requests to cancel authentication from the system either when the first user logs out of the system or when no service use is input from the user for a predetermined time.

5. A message transmission method in a system connected to a plurality of user terminals through a network, the message transmission method comprising:
a) the system performing first authentication on a first user based on user ID information provided by a first user terminal connected to the wired Internet wherein the user terminal includes a client processing device;
b) the system receiving a wireless telephone number from the first user terminal, and performing second authentication in cooperation with a first portable terminal having the wireless telephone number; and
c) the system transmitting a message provided by the first user terminal having undergone the first and second authentication to at least two second users' terminals, wherein
the second users' terminals include a wireless terminal and a wired terminal.

6. The message transmission method according to claim 5, further comprising the system charging the fee on the message transmission by the first user terminal to the wireless telephone number provided by the first user terminal.

7. The message transmission method of claim 6, wherein the system generates billing data including the wireless telephone number, the first user terminal's ID information, ID information on the service indicating message transmission, and the first user's authentication period.

8. A recording medium storing a program for realizing the method disclosed in claim 5.

9. A message transmission system connected to a plurality of user terminals through a network, the message transmission system comprising:
an authentication server for authenticating a user;
a message transmission server for concurrently transmitting a message provided by the authenticated first user terminal to at least two second users' terminals; and
a billing server for performing a billing process according to the first user's message transmission, wherein
the message transmission server transmits the message in cooperation with a client processing device installed in the first user terminal, and the second user terminal includes a wired terminal and a wireless terminal.

10. The message transmission system of claim 9, wherein the client processing device comprises:
a message transmission request module for providing a predetermined message to the system and requesting message transmission;
a received message processing module for processing the message transmitted by a predetermined terminal through the system;
an authentication request module for transmitting user ID information and a wireless telephone number to the system and requesting authentication wherein the ID information includes at least one of an IP address and a MAC address assigned to the terminal; and
an authentication cancellation request module for transmitting user ID information to the system and requesting to cancel authentication.

11. The message transmission system of claim 10, wherein the authentication server comprises:
an authentication database for storing information for user authentication; and
an authentication processor for performing first authentication on the user based on the user ID information provided by the authentication request module of the client processing device and information stored in the authentication database, and performing second authentication on the user based on a wireless telephone number provided by the authentication request module.

12. The message transmission system of claim 11, wherein the authentication processor stores the authenticated user's ID information in the authentication database, and deletes the user's ID information stored in the authentication database to cancel authentication when a authentication cancellation is requested from the client processing device.

13. The message transmission system according to claim 9, wherein the message includes at least one of charged contents including a multimedia message, sound, and pictures.

14. The message transmission method according to of claim 1 further comprising the system charging the fee on the message transmission by the first user terminal to the wireless telephone number provided by the first user terminal.

15. A recording medium storing a program for realizing the method disclosed in claim 1.
